(19) United States
(12) Patent Application Publication
(10) Pub. No.: US 2025/0370838 A1
(43) Pub. Date: Dec. 4, 2025

(54) DIAGNOSTIC SYSTEM FOR CONTINUOUS INTEGRATION TESTING PIPELINE

(71) Applicant: Microsoft Technology Licensing, LLC, Redmond, WA (US)

(72) Inventors: Maya PEGLER-GORDON, Seattle, WA (US); Sandeep KUMAR, Snohomish, WA (US); Derek Andrew PARK, Seattle, WA (US); Bharat KANDOI, Kirkland, WA (US); Jason Orlando ALMARAZ, Anaheim, CA (US); Jeremy HAUBOLD, Valparaiso, IN (US)

(73) Assignee: Microsoft Technology Licensing, LLC, Redmond, WA (US)

(21) Appl. No.: 18/677,999

(22) Filed: May 30, 2024

(51) Int. Cl. G06F 11/07; G06F 11/36

(52) U.S. Cl. CPC G06F 11/0766; G06F 11/3688; G06F 11/3692

(57) ABSTRACT

A data processing system includes: a processor; and a memory in communication with the processor, the memory comprising executable instructions. When executed by the processor alone or in combination with other processors, the instructions cause the data processing system to perform functions of: detecting failure of a main Continuous Integration Testing (CIT) pipeline that is testing artifacts of a build pipeline; determining a known-good artifact tested previously by the main CIT pipeline; instantiating a duplicate CIT pipeline and retesting the known-good artifact with the duplicate CIT pipeline; determining whether the retest of the known-good artifact was successful or a failure in the duplicate CIT pipeline; and in response to failure of the duplicate CIT pipeline, enhancing an incident ticket with notice that the failure of the main CIT pipeline is due to an external dependency failure.

### BACKGROUND

The term “cloud services” refers to a variety of online platforms or applications that offer users the ability to store, manage, and share digital files and documents remotely. These services or applications utilize internet-based servers to store data, allowing users to access their files from anywhere with an internet connection. These services often include features for collaboration, allowing multiple users to work on the same documents simultaneously and track changes made by different contributors. Additionally, they typically offer security measures to protect sensitive information and ensure data privacy.

In such online services or applications, the underlying code for the service is kept in a central repository by the service provider. Updates and improvements to the code may be made by developers, over time, to remove bugs, add features or generally update the service. A Pull Request (PR) initiates the integration of code changes into the codebase. The idea is to have developers merge their changes into a main branch of the codebase often, sometimes multiple times a day. This ensures that new code is regularly integrated with the existing codebase in smaller increments. This reduces the chances for conflicts and makes it easier to detect and fix any issues that do arise.

Consequently, as new code is introduced, it is important to test for issues that may inadvertently be caused as the new code is integrated into the codebase. Continuous Integration Testing (CIT) involves automatically running tests on the integrated code to check if everything is working as expected. These tests can include unit tests (which check individual components), integration tests (which check how different components work together), and other types of tests. Typically, a CIT pipeline continuously runs test jobs against new code changes as they merge into the codebase.

When CIT fails, an issue is indicated, and the cause of the failure must be determined. While it may be presumed that recently introduced code has caused the problem, this is not always the case. Some other causes of failure may happen to coincide with the introduction of new code, particularly if new code is being introduced on a nearly continuous basis. External outages can also cause CIT failures and are one of the main factors negatively impacting PR reliability.

However, it can be very difficult to identify whether a CIT failure is due to an internal issue, such as bad code being checked in to the codebase, or to an external issue. Answering this question can take hours of time for an engineer responding to a CIT failure. This may also cause significant additional downtime or outage for the service. For this reason, there is a need for additional diagnostic tools that can assist an engineer to determine more quickly whether the cause of a CIT failure is internal or external to the service.

### SUMMARY

In one general aspect, the following description presents a data processing system includes: a processor; and a memory in communication with the processor, the memory comprising executable instructions. When executed by the processor alone or in combination with other processors, the instructions cause the data processing system to perform functions of: detecting failure of a main Continuous Integration Testing (CIT) pipeline that is testing artifacts of a build pipeline; determining a known-good artifact tested previously by the main CIT pipeline; instantiating a duplicate CIT pipeline and retesting the known-good artifact with the duplicate CIT pipeline; determining whether the retest of the known-good artifact was successful or a failure in the duplicate CIT pipeline; and in response to failure of the duplicate CIT pipeline, enhancing an incident ticket with notice that the failure of the main CIT pipeline is due to an external dependency failure.

In another general aspect, the following description presents a diagnostic tool for a Continuous Integration/Continuous Deployment (CI/CD) system having a codebase repository and build and release pipelines, the diagnostic tool to identify failure in an external dependency as a cause of a failure in Continuous Integration Testing (CIT). The diagnostic tool includes a processor; and a memory in communication with the processor, the memory comprising executable instructions that, when executed by the processor alone or in combination with other processors, cause the processor to implement an agentless task to perform functions of: detecting and responding to a testing failure of a main Continuous Integration Testing (CIT) pipeline that is testing artifacts of the build pipeline; determining a known-good artifact tested by the main CIT pipeline previous to the failure; instantiating a duplicate CIT pipeline; rerunning CIT based on the known-good artifact with the duplicate CIT pipeline; determining a testing failure of the duplicate CIT pipeline; and enhancing an incident ticket for the testing failure in the main CIT pipeline with notice that the testing failure of the main CIT pipeline is due to an external dependency outage.

In another general aspect, the following description presents a method of diagnosing a Continuous Integration/Continuous Deployment (CI/CD) system having a codebase repository and build and release pipelines, the method to identify failure in an external dependency as a cause of a failure in Continuous Integration Testing (CIT). The method includes: detecting and responding to a testing failure of a main Continuous Integration Testing (CIT) pipeline that is testing artifacts of the build pipeline; determining a known-good artifact tested by the main CIT pipeline previous to the failure; instantiating a duplicate CIT pipeline; rerunning CIT based on the known-good artifact with the duplicate CIT pipeline; determining a testing failure of the duplicate CIT pipeline; and enhancing an incident ticket for the testing failure in the main CIT pipeline with notice that the testing failure of the main CIT pipeline is due to an external dependency outage.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 depicts an example system upon which aspects of this disclosure may be implemented.

FIG. 2A is a flowchart depicting a possible operation of the example system shown in FIG. 1.

FIG. 2B is an alternative depiction of an example system implementing the method of FIG. 2A.

FIG. 2C is a flowchart depicting an example of the incident management or ticketing function of the system described.

FIG. 3 is a flowchart depicting an alternative example operation of the system shown in FIG. 1.

FIG. 4 is a flowchart depicting an alternative example operation of the system shown in FIG. 1.

FIG. 5 is a flowchart depicting a feature avoiding unnecessary reporting of transient external outages.

FIGS. 6A and 6B illustrate a reduced set of stages that may be used in the duplicate CIT pipeline as compared to the main CIT pipeline.

FIG. 7 is a block diagram illustrating an example software architecture, various portions of which may be used in conjunction with various hardware architectures herein described.

FIG. 8 is a block diagram illustrating components of an example machine configured to read instructions from a machine-readable medium and perform any of the features described herein.

### DETAILED DESCRIPTION

By definition, internal causes of a CIT failure are internal to the cloud service or the CIT pipeline itself. For example, internal causes of CIT failure include bad code being checked into the codebase or a bad test being included in the CIT process. On the other hand, the cloud service may utilize and rely on other services that provide capabilities or infrastructure that the cloud service uses. For example, a cloud service may call an analytics engine for data analysis of it database. If such an underlying service, also called a dependency, fails or experiences an issue, that problem will impact the supported cloud service and may cause CIT for the cloud service to fail. External outages are generally due to a third-party dependency experiencing an outage.

As noted above, external outages are one of the main factors negatively impacting Pull Request (PR) reliability. It is critical for engineering systems to maintain high PR reliability to enable developers to safely and confidently ship new features. Currently, when an On-Call engineer (OCE) receives an alert, it can take hours of investigation to identify whether the issue is external. Typically, top suspects for failures include bad code check-ins or transient failing tests. OCEs will often spend hours investigating these internal failure causes before suspecting there is an underlying external dependency tied to the root cause of the failures.

Consequently, while external outages represent a smaller percentage of overall failures, they have an outsized impact on PR reliability. This is due to the fact that OCEs do not have tools to determine the root cause for external outage scenarios. Ideally, the error messages and logs would clearly point to the failing external system. But that is often not the case for large and complex repositories. Without effective tools to help OCEs interpret and categorize failures, external outages can take engineering systems down for hours and block engineers from being able to test or check in new code changes.

To address this technical problem, the following description proposes a technical solution of creating a duplicate CIT pipeline which is run a previously known-good release artifact. More specifically, this technique includes duplicating the main CIT validation pipeline and rerunning key stages based off a previously successful instance of the codebase. Using this new baseline source of truth, if both the existing main CIT and new previously known-good CIT runs are failing, the system can confidently determine something external has changed and alert OCEs that there is an external outage.

In other words, a recent run of the CIT pipeline that previously tested successfully is rerun. If the duplicate CIT pipeline now fails or fails consistently with matching failures, this indicates with high confidence that the current issue is due to an external, rather than an internal, issue. This is the case because, if the duplicate CIT pipeline already tested successfully, is rerun, and now fails, the difference must be due to an external dependency that was functioning properly when the duplicate CIT pipeline was first run, but is in failure for the unsuccessfully rerun of the CIT pipeline. In this case, the OCE will save significant time by no longer needing to investigate internal issues, such as bad code check-ins, and reverting recent pull requests. Rather, the OCE can promptly alert the partner teams that the issue is due to an external cause. The remediation can then focus on determining which external dependency of the cloud service is in failure.

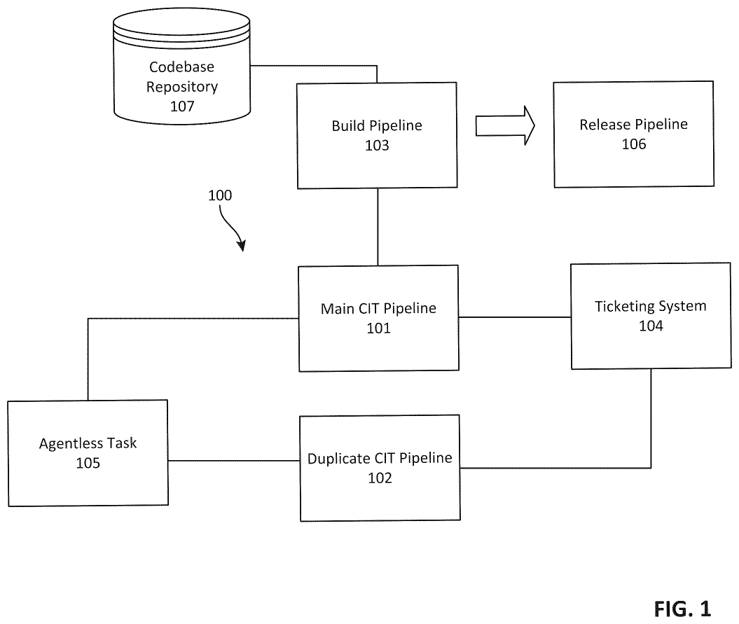

FIG. 1 depicts an example system upon which aspects of this disclosure may be implemented. Specifically, FIG. 1 depicts a system 100 implementing the diagnostic technique described. As shown in FIG. 1, a build pipeline operates on a codebase in a codebase repository 107 as pull requests are made. The build artifacts of the build pipeline 103 are output to a release pipeline 106.

A build pipeline and a release pipeline are two integral components of a Continuous Integration/Continuous Deployment (CI/CD) system. The build pipeline is a series of automated steps that take the source code from its raw form in the codebase repository and transform it into a deployable product. This typically involves compiling code, running tests, packaging the application, and possibly other tasks like code analysis or documentation generation.

A release pipeline is similar but focuses on the steps needed to deploy the built application to a production environment. This can involve tasks like deploying the application to servers, setting up databases, configuring networking, and so on. The build pipeline produces artifacts that are consumed by the release pipeline for deployment.

A release is a construct that holds a versioned set of artifacts specified in a CI/CD pipeline. It includes a snapshot of all the information required to carry out all the tasks and actions in the release pipeline, such as stages, tasks, policies such as triggers and approvers, and deployment options. In this context, the release pipeline is responsible for running the CIT testing on a set schedule to ensure no bad code check ins are getting through to deployment. A single instance of the CIT release pipeline run holds a release artifact, which contains information about the version of code checked in at the time of testing.

As shown in FIG. 1, a build pipeline 103 supports operation of a particular cloud service. The output of the build pipeline 103 is a series of artifacts. Term “artifact” refers to any generated or output file or collection of files that result from a given process. Thus, the build pipeline 103 will produce build artifacts. These artifacts typically include compiled code, executables, libraries, configuration files, documentation, or any other files produced during the build. The output of a release pipeline may similarly be referred to as a release artifact. Once the build is completed successfully, the resulting artifacts are often packaged together and stored in a build repository of the build pipeline 103 or other designated location.

As described above, the main CIT pipeline 101 has the job of continuously accessing artifacts generated by the build pipeline 103 and testing those artifacts to ensure that the artifact is functioning as expected and intended, meaning that the newly-integrated code is functioning and not causing issues. If the CIT pipeline 101 fails this indicates that there is a problem internal to the artifact under test or to a dependency that the artifact utilizes for operation.

An incident is an unplanned interruption to the service. OCEs are alerted of incidents with a ticket, or notification, which contains information about the type of failure and guides on mitigation. More specifically, when the CIT pipeline 101 detects an incident, a ticketing system 104 is notified. The ticketing system 104, also known as an Incident Management System, generates a ticket corresponding to the incident. The ticket includes notification to a technician, such as a designated OCE, that an incident has occurred that requires remediation.

To assist the OCE, the system of FIG. 1 introduces a process in the form of an agentless task 105. The agentless task 105 performs the function of continuously inspecting a history of the main CIT pipeline 101 and the artifacts tested. The agentless task 105 contains logic for identifying, in the history of the main CIT pipeline, a relevant artifact version. This may be a recent, or the most recent, artifact that was tested successfully. For artifacts that tested successfully in the main CIT pipeline 101, i.e., known good artifacts, the agentless task 105 retests those artifacts with a duplicate CIT pipeline 102. The duplicate CIT pipeline 102 can be a clone of the main CIT pipeline 101. The duplicate CIT pipeline may be cloned from the main CIT pipeline 101 for each run of the duplicate CIT pipeline so that the two pipelines are always congruent.

For efficiency, the duplicate CIT pipeline may include only a subset of the test stages of the main CIT pipeline. Specifically, after cloning, the duplicate CIT pipeline 102 may be reduced to only a subset of key stages that are needed for validation of an artifact. As noted above, CIT can include a number of different types of tests such as unit tests (which check individual components), integration tests (which check how different components work together), and other types of tests. The different tests are grouped in stages for CIT, each stage contains a different subset of tests. Some stages run for a Pull Request and are required to pass before integrating the new code changes of the PR. Others are optional or are not present in a PR and are only run against new code changes once those changes integrate into the codebase. Such tests must pass before the new code changes deploy to the production environment. In some examples, the stages are also not grouped solely based on whether or not they are required in PR. They could also just be grouped as different types of tests such as unit tests, tests for specific operating systems (ex. Mac, Windows), etc. Consequently, to avoid wasting resources, the system allows for the duplicate CIT pipeline to run a reduced set of key stages for desired validation. For example, the stages mirrored may be only the stages that directly impact pull requests, enabling users to check in code changes. If these stages are failing, users are unable to check in code changes and therefore should be monitored indications of for external outages. These stages also have a higher reliability, which will improve alert accuracy.

As will be described in more detail below, the agentless task 105 may also operate on a number of configurable variables, such as a number of hours to lookback for a known-good artifact and a maximum number of hours for lookback. The agentless task 105 may also have a listing of relevant or key stages in the CIT pipeline that need to have been “green” or successful for the corresponding artifact to be considered successfully tested and a known-good artifact. In this way, an artifact that may not have passed a less significant portion of the previous CIT can still be used as a known-good artifact. This also allows the agentless task to be configurable by administrators as to the stages of interest. Thus, the agentless task 105 provides the ability to configure conditions for which release artifact will initiate a duplicate release run, such as age of the release or number of successful releases since release creation.

In this system 100, only known-good artifacts that previously tested successfully to a minimum standard with the main CIT pipeline 101 are retested by the duplicate CIT pipeline 102. Consequently, if the duplicate CIT pipeline 102 fails when testing a previously successful artifact, this indicates with high confidence that something external has changed since the previous successful test of the artifact. When this occurs, the ticketing system 104 is notified of the failure in the duplicate CIT pipeline 102. The ticketing system 104 can then enhance a ticket with notice, based on a failure in the duplicate CIT pipeline 102, that the source of the issue is external, and not internal. Consequently, when the ticket is reviewed by an OCE, no time is wasted searching for an internal cause of the failure in the main CIT pipeline 101. Attention can be immediately directed to external dependencies that might be causing the main CIT pipeline 101 failure.

Considered in greater detail, the agentless task 105 takes input parameters which provides the ability to configure conditions for which release to select as the “previously successful run,” such as age of release or number of successful releases since release creation. At a high level, the agentless task (1) syncs duplicate CIT stages and variables from the Main CIT in case any got updated in the main CIT; (2) queries for previous releases within input parameters valid time frame; and (3) selects previously successful CIT run to restart in Duplicate CIT pipeline.

The system has the ability to configure how the candidate release to be retested is identified by, for example, the release age, required stages, number of successful runs required to weed out transient issues, etc. Consequently, the input parameters for the agentless task 105 may include:
1. A parameter that maps to a definition identification of the main CIT release pipeline
2. A parameter that maps to definition identification of the duplicate CIT release pipeline
3. A parameter specifying a minimum number of hours passed since the candidate release ran
4. A parameter specifying a maximum number of hours to look back for the candidate release, i.e., candidate releases cannot be older than x.
5. A parameter that maps to the main CIT stage names that must have passed in candidate release
6. A parameter specifying a number of runs passed since the candidate release ran, intended to weed out transient failures.

Thus, the agentless task 105 will contain logic to determine which previous run to use in a duplicate CIT run. For example, the release must be within x and y hours old as determined by input parameters. The agentless task 105 may include an input parameter to indicate release stages that must pass for the release to be considered successful. The agentless task 105 may also include an input parameter such as that specifies a number of releases that have been run since the artifact selected for the duplicate CIT pipeline.

Once the agentless task 105 selects the previous run of the main CIT pipeline to rerun in the duplicate CIT pipeline, the agentless task 105 retrieves the build artifact of the candidate run. This artifact represents the code version of the codebase at the time of that integration test run. The agentless task 105 supplies the artifact to create a new release run in the duplicate CIT pipeline. This is essentially rerunning the validation tests off of a previously successful instance of the codebase from x hours ago. If the previously successful run is now failing consistently, the agentless task will enhance the CIT ticketing system to indicate there is an external outage. If the duplicate run succeeds, there is no external issue indicated and no additional action need be taken by the system.

In some cases, the agentless task 105 is not be able to identify a previous successful run of the main CIT pipeline. This may indicate that the main CIT pipeline has not been running successfully and there is a larger underlying issue. Accordingly, the agentless task 105 generates an expected error and monitors on task fires if the task consistently fails. In an example, the agentless task 105 could be implemented through a configuration file, such as a Yet Another Markup Language (YAML) file or other language configuration file.

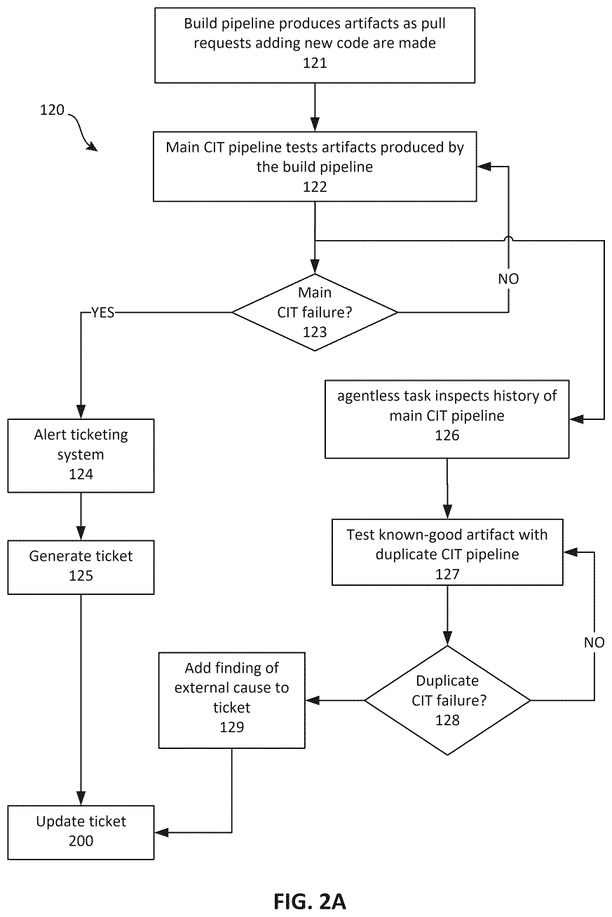

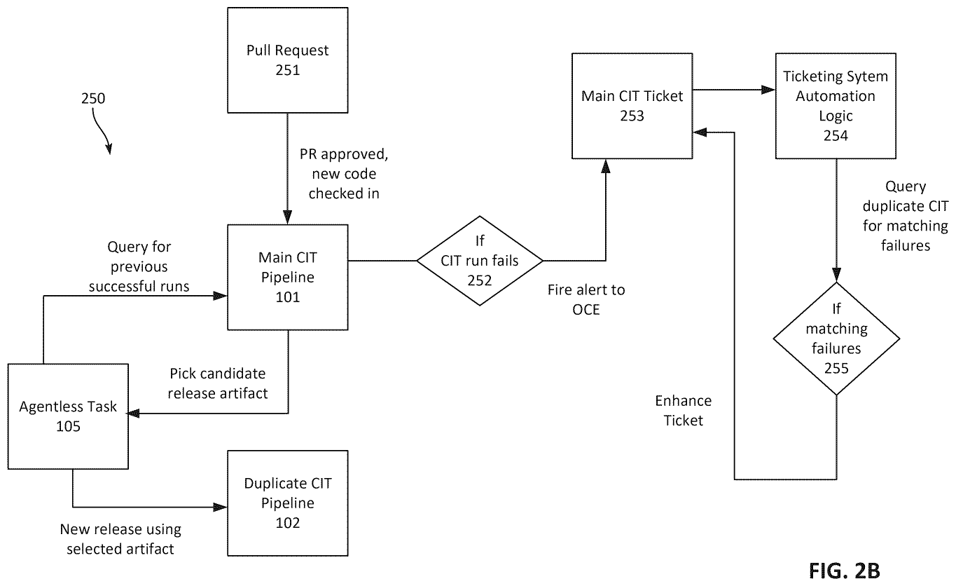

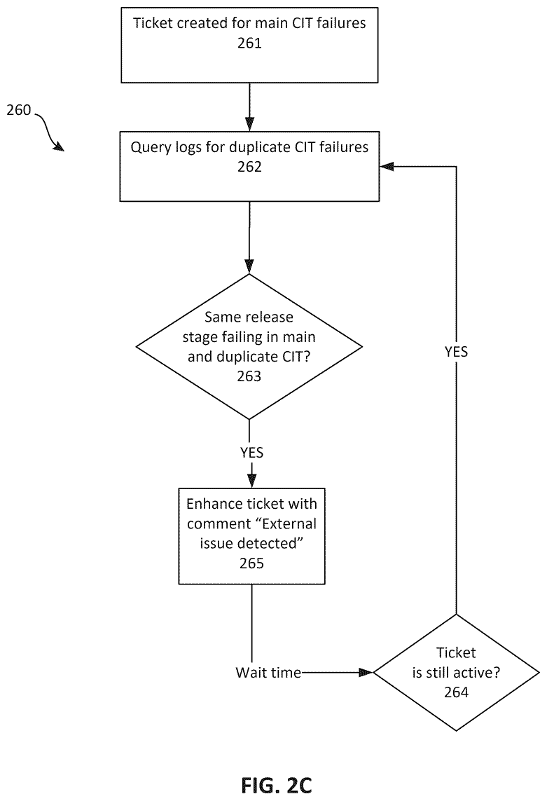

FIG. 2A is a flowchart 120 depicting a possible operation of the example system shown in FIG. 1. As shown in FIG. 2A, the build pipeline operates to produce 121 executable artifacts, particularly as pull requests are made adding new code to the codebase. As described above, the main CIT pipeline tests 122 the artifacts produced by the build pipeline. This helps prevent bugs or issues created by a bad code check-in being introduced into the production environment.

When an issue does occur, the main CIT will fail 123. Until this occurs, the method loops with the main CIT pipeline continuing to test artifacts produced by the build pipeline. When such a failure does occur 123, a ticketing system is alerted 124, and a ticket is generated 125. The identified failure is not necessarily a single failure but may more likely be when the CIT pipeline exceeds a configurable failure threshold. As noted above, this ticket will notify an OCE that failure requiring remediation has occurred. Once the ticket is created, the system may initiate logic that regularly, e.g., every hour, queries for new matching failures and updates the ticket with relevant information.

When the main CIT pipeline fails 123, the failure could be the result of some internal issue, such as bad code or a flaky test, such as a test that fails intermittently due to a transient issue, or could be the result of an external issue such as the failure of an external dependency on which the cloud service or application relies. As described above, the present technique helps resolve this question. The technique being described may operate in a number of different ways. For example, runs of the duplicate CIT pipeline may be made continuously, may only be made in response to the main CIT failure or made in response only to a user command upon the main CIT failure.

FIG. 2A illustrates the case in which the agentless task 105 is continuously operating a duplicate CIT pipeline to retest known-good artifacts previously tested by the main CIT pipeline. This is to reduce the time needed to identify external outages because a single CIT run can take hours to complete. If the system waits for an initial main CIT failure before running checks with the duplicate CIT, the OCE may still be waiting a significant amount of time before being able to more effectively address the root cause and find a solution to the issue. Consequently, the agentless task checks for external outages by operating the CIT pipeline on a continuous or regular basis. For example, the agentless task may operate the duplicate CIT pipeline at the same cadence as the main CIT pipeline to quickly identify external issues.

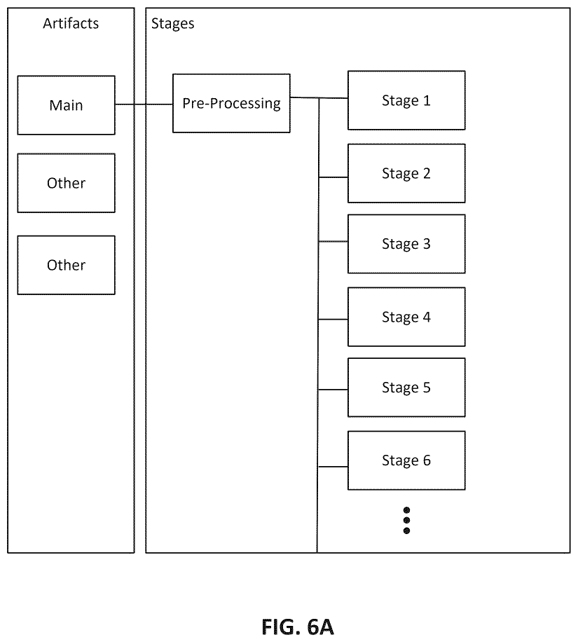

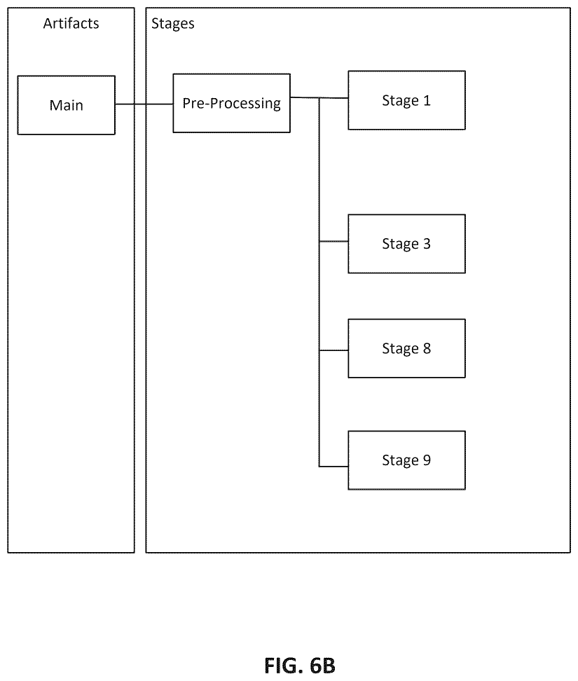

Additionally, the system can run a reduced set of integration tests in the duplicate pipeline to avoid wasting resources. Specifically, the system may only run the policies that, if they fail, engineers are unable to check in new code changes. This is described further below with reference to FIGS. 6A and 6B.

Consequently, on a continuous or regular basis, the agentless task inspects 126 the history of the main CIT pipeline including the artifacts that have been tested to identify a recent artifact, for example, a most recent artifact, that the main CIT pipeline tested successfully. The agentless task then tests, i.e., retests 127, this known-good artifact with the duplicate CIT pipeline. If the duplicate CIT pipeline fails 128, this indicates that the reason for the main CIT failure is external to the cloud service, e.g., an external dependency of the cloud service.

In some cases, however, the external issue causing the problem may be transient and resolves quickly without further action. In such a case, it is inefficient to prematurely alert the OCE to the incident. More specifically, CIT pipelines may experience intermittent one-off failures due to a complex number of dependencies and external connections. This is to be expected. Consequently, the duplicate CIT system can include a configurable factor, referred to, in an example, as the TransientIssueBuffer, to ensure that failures are consistent and repeated before determining there is an external outage. Specifically, to improve alert accuracy, the system may repeat a test with the duplicate CIT pipeline and require a minimum number of failures, or failures over a set period of time, before the finding is made that an external dependency is in failure. This may give the external dependency a chance to recover from a transient issue without the OCE being unnecessarily alerted. This transient threshold can be configurable based on the reliability of a given CIT. For example, a more reliable CIT can have a lower transient issue buffer. Alternatively, a lot of smaller repositories have less reliable CIT pipelines and therefore would have a higher transient issuer buffer.

When deemed appropriate, this finding of an external dependency being responsible for the main CIT failure is added 129 to the corresponding ticket generated by the ticketing system. The ticket is then updated 200 for the team of OCEs. As noted above, this notation on the ticket can save the OCEs significant lost time looking for an internal cause of the CIT failure when the cause is actually an external dependency.

In this scenario, where the agentless task is operating on a continuous basis, if the duplicate CIT pipeline successfully retests 128 the known-good artifact, the process may loop with the agentless task then identify another, subsequent, known-good artifact from the history of the main CIT pipeline and proceed with retesting that subsequent artifact with the duplicate pipeline.

When the duplicate CIT pipeline fails 128, perhaps for a minimum number of times to account for transient issues, a finding that the failure of the main CIT is due to an external issue is reached. This finding can then be added 129 to a ticket issued on the main CIT failure. As shown in FIG. 2A, the ticket is updated 200.

FIG. 2B is an alternative depiction of a possible system implementing the method of FIG. 2A. As shown in FIG. 2B and as noted above, when new code is to be integrated into the codebase, a pull request 251 is made. When the pull request is approved, new code is checked into the codebase. The main CIT pipeline 101 continually runs integration tests on the current codebase. Consequently, if bad code is checked in, the CIT pipeline 101 should detect the issue before it slips to the production environment.

During operation of the main CIT pipeline 101, the agentless task 105, as described above, will continually or regularly query the main CIT pipeline 101 for previously successful runs. As a result of this query, the agentless task 105 will receive one or more release artifacts from previous successful runs of the main CIT pipeline 101. The agentless task 105 will select a previously-successful release artifact. For example, the selected artifact may be a most recent successful release artifact. The agentless task 105 will then initiate a new release using the selected artifact with the duplicate CIT pipeline 102. As noted, this can happen continually, for example, at the same cadence as operation of the main CIT pipeline 101.

If the CIT pipeline 101 run fails 252, a fire alert indicating to the OCE that the main CIT is unhealthy is made. A main CIT ticket 253 is generated. The ticketing system automation logic 254 will then query the duplicate CIT pipeline 102 for matching failures 255. If the duplicate CIT pipeline 102, which only operates on previously-successful release artifacts reports a matching failure, this indicates that a release artifact the was previously-successful has not failed, presumably due to the failure of an external dependency. Consequently, the ticket 253 is enhanced with the indication that the root cause of the incident is external with a high confidence level.

FIG. 2C is a flowchart depicting an example of the incident management or ticketing function of the system described. As shown in FIG. 2C, once the ticket is created for failures in the main CIT 261, the technique queries logs of the duplicate CIT pipeline for matching failures 262. If the same release stage is failing in the main and duplicate CIT pipelines 263, the ticket is enhanced, for example, with a comment such as “External issue detected” 265. The system may then wait a period of time, such as an hour, and then check whether the ticket is still active 264. If the ticket is still active, the technique again queries logs of the duplicate CIT pipeline for matching failures 262 if new or continuing failures are detected. The technique then loops to indicate whether an external issue is still the likely cause of the incident.

In other words, for every period of time that the ticket is active, e.g., hourly, there is a query for main and duplicate CIT failures. If there are corresponding failures in the main and duplicate CIT pipelines for the incident's failing stage, the technique updates the ticket with a link to the duplicate CIT pipeline summary and with a message such as “duplicate CIT is also unhealthy, which likely indicates an external outage: please investigate and reach out to external partners.” If there are no corresponding failures and the ticket is still active, the ticket can be updated with a comment such as “duplicate CIT is reporting healthy, which likely indicates the external incident has resolved.”

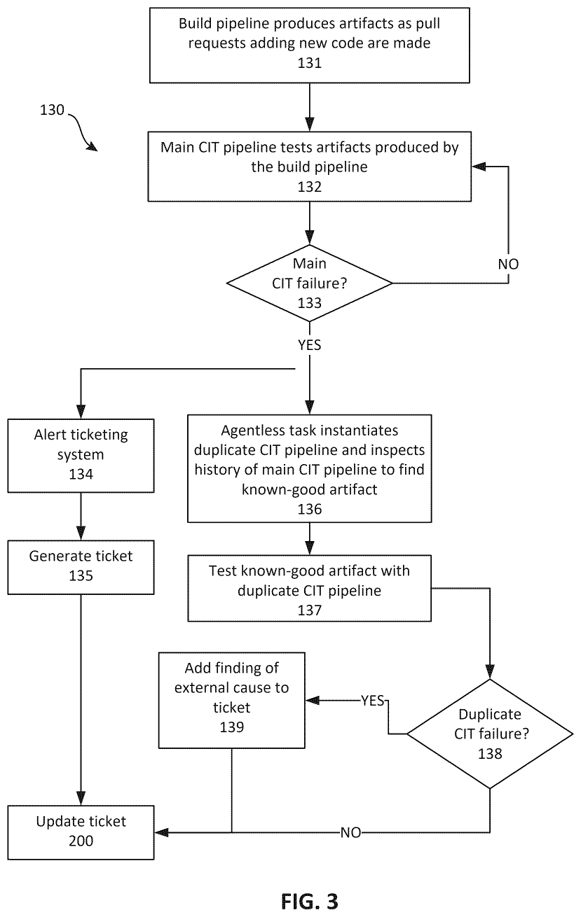

FIG. 3 is a flowchart 130 depicting an alternative example operation of the system shown in FIG. 1. In this alternative operation, failure of the main CIT pipeline is used to trigger operation of the agentless task. Referring to FIG. 3, as before, the build pipeline operates to produce 131 executable artifacts, particularly as pull requests are made adding new code to the codebase. The main CIT pipeline tests 132 the artifacts produced by the build pipeline. When an issue occurs, the main CIT will fail 133. As before, the ticketing system may be alerted 134 and may generate a ticket 135.

In this example, the failure of the main CIT pipeline also triggers the agentless task to instantiate 136 a duplicate CIT pipeline and inspect 136 the history of the main CIT pipeline to identify a known-good artifact. The agentless task then retests 137 the known-good artifact in the duplicate CIT pipeline.

If the duplicate CIT fails 138, the indication is that an external dependency has caused the main CIT failure and this finding is added 200 to the ticket. The enhanced ticket is then provided to the team of OCEs. If the duplicate CIT does not fail 138, no such notation is added to the issued ticket.

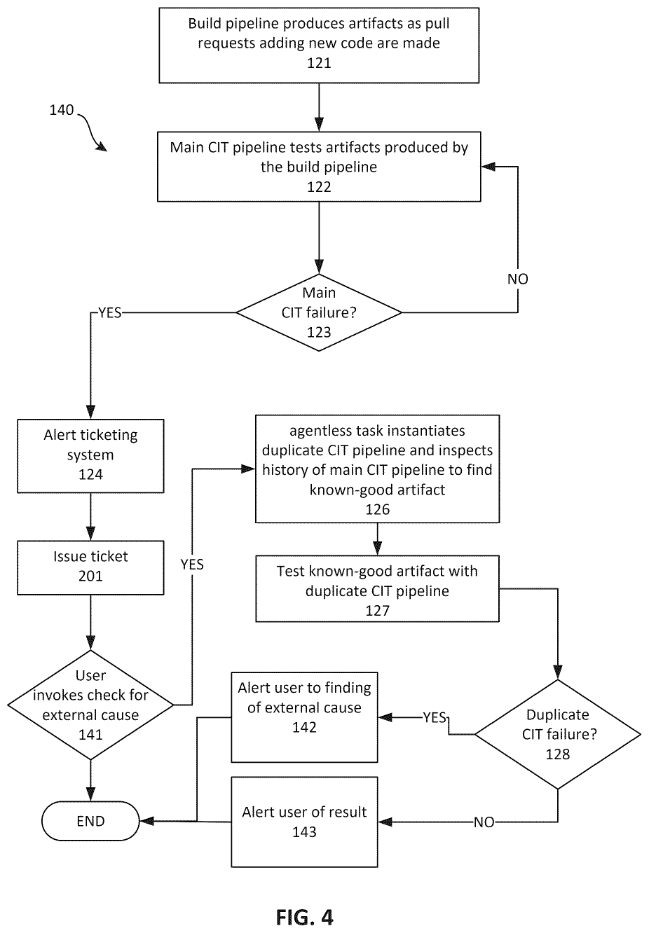

FIG. 4 is a flowchart 140 depicting an alternative example operation of the system shown in FIG. 1. The flow of FIG. 4 has some similarities with those of FIGS. 2 and 3 above. However, FIG. 4 depicts an example in which the user selectively invokes the agentless task and duplicate CIT pipeline to check for external issues.

As shown in FIG. 4, when the main CIT fails 123, the ticketing system is alerted 124 and a ticket is issued 201. This will notify the OCE that action needs to be taken. With the ticketing system user interface, the user can invoke 141 a check for whether the main CIT failure has been caused by an external issue. When this option is invoked 141, the agentless task instantiates 126 the duplicate CIT pipeline and inspects the history of the main CIT pipeline to find an appropriate known-good artifact for retest, as described above. As before, the known-good artifact is tested 127 with the duplicate CIT pipeline. If the duplicate CIT pipeline fails 128, the user interface alerts 142 the user that the cause of the main CIT pipeline failure is likely external to the cloud services. If the duplicate CIT pipeline does not fail 128, the user can also be alerted 143 of that result.

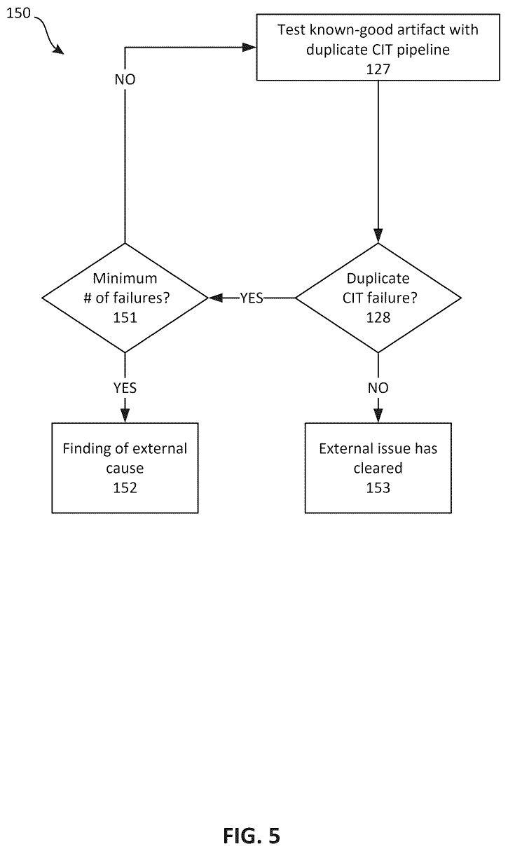

FIG. 5 is a flowchart 150 depicting an example operation of the duplicate CIT pipeline. As noted above, an external dependency to the cloud service may experience a transient issue that causes it to be inoperative for a relatively short time. In such as case, it would be inefficient to notify the OCE of a failure of the main CIT pipeline that will resolve as soon as the transient issue in the external dependency clears.

Consequently, as shown in FIG. 5, a mechanism can be implemented in any of the examples described herein to account for such transient issues in an external dependency. As shown in FIG. 5, testing 127 of a known-good artifact is conducted with a duplicate CIT pipeline. If the duplicate CIT pipeline fails 128, this indicates an external issues causing the antecedent failure in the main CIT pipeline.

However, the system may delay issuing a ticket or any other alert to the OCE until waiting to determine if the external issue is transient and will clear, for example, within a set amount of time. For example, upon failure of the duplicate CIT 128, the process checks to see if the CIT has failed a minimum number of times 151. If not, the test of the known-good artifact on the duplicate CIT is rerun 128 until the minimum number of failures is reached 151. At that point, the external issue is confirmed and reported to the OCE, e.g., by issuing a ticket, as described above, that indicates an external issue has been identified.

If, at any time during this loop, the duplicate CIT succeeds, the system will determine that the external issue has cleared 153. In this case, no alert need be sent to the OCE. Consequently, the reporting to the OCE is made more accurate and unnecessary alerts due to transient external issues are avoided.

FIGS. 6A and 6B illustrate possible differences between the main and duplicate CIT pipelines. As noted, the system utilizes a duplicate CIT pipeline which runs the same set of integration tests off a previously successful instance of the codebase. The system finds the previously successful instance of the codebase by looking back through previously successful CIT runs. Once the system finds a previously successful CIT run, the logic selects the release artifact (piece of the release run containing information about the state of the codebase, such as the code version, at the time of the run) and supplies the release artifact in the new duplicate baseline CIT run. This is essentially rerunning the same integration tests off code changes from x hours ago, that have already passed the integration tests. Through creating this baseline, if the previously successful instance of the integration tests begins to fail and matching failures are observed in the main and duplicate CIT runs, the system can determine that something external has changed, resulting in the failures.

Consequently, FIG. 6A depicts the main CIT pipeline containing additional non-essential stages beyond the specifically required validation test stages. FIG. 6B depicts the duplicate CIT pipeline containing only a subset of the main CIT stages, i.e., only stages required for pull request validation. Several of the test stages in the CIT pipeline are also mirrored in PR validation. Engineering systems run several validation tests at the time of PR review, prior to merging, to ensure the proposed code changes are safe to integrate into the main codebase. In the case that the CIT pipeline is failing one of the PR required stages, it means engineers cannot integrate code changes as the tests to safely validate their code changes are unable to succeed. This is one of the main reasons it is very important OCEs are quickly able to determine the root cause of CIT failures and mitigate the issue, to ensure engineers are able to continue developing and shipping new features.

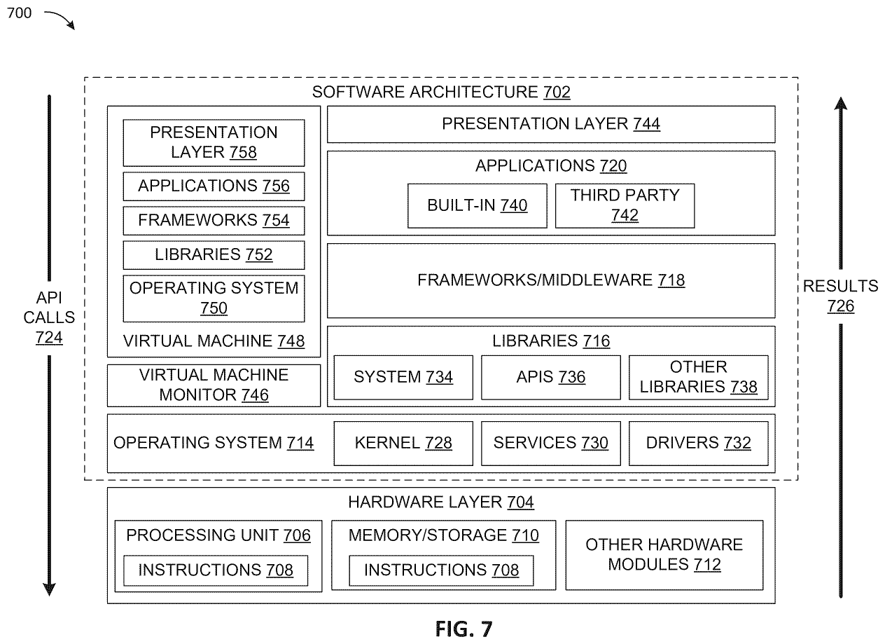

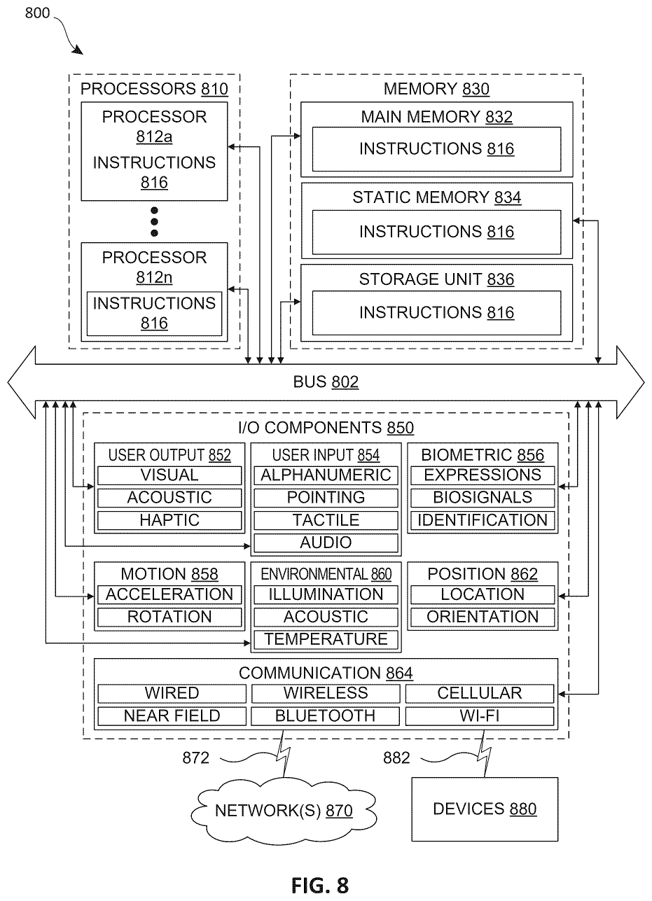

FIG. 7 is a block diagram 700 illustrating an example software architecture 702, various portions of which may be used in conjunction with various hardware architectures herein described, which may implement any of the above-described features. FIG. 7 is a non-limiting example of a software architecture, and it will be appreciated that many other architectures may be implemented to facilitate the functionality described herein. The software architecture 702 may execute on hardware such as a machine 800 of FIG. 8 that includes, among other things, processors 810, memory 830, and input/output (I/O) components 850. A representative hardware layer 704 is illustrated and can represent, for example, the machine 800 of FIG. 8. The representative hardware layer 704 includes a processing unit 706 and associated executable instructions 708. The executable instructions 708 represent executable instructions of the software architecture 702, including implementation of the methods, modules and so forth described herein. The hardware layer 704 also includes a memory/storage 710, which also includes the executable instructions 708 and accompanying data. The hardware layer 704 may also include other hardware modules 712. Instructions 708 held by processing unit 706 may be portions of instructions 708 held by the memory/storage 710.

The example software architecture 702 may be conceptualized as layers, each providing various functionality. For example, the software architecture 702 may include layers and components such as an operating system (OS) 714, libraries 716, frameworks 718, applications 720, and a presentation layer 744. Operationally, the applications 720 and/or other components within the layers may invoke API calls 724 to other layers and receive corresponding results 726. The layers illustrated are representative in nature and other software architectures may include additional or different layers. For example, some mobile or special purpose operating systems may not provide the frameworks/middleware 718.

The OS 714 may manage hardware resources and provide common services. The OS 714 may include, for example, a kernel 728, services 730, and drivers 732. The kernel 728 may act as an abstraction layer between the hardware layer 704 and other software layers. For example, the kernel 728 may be responsible for memory management, processor management (for example, scheduling), component management, networking, security settings, and so on. The services 730 may provide other common services for the other software layers. The drivers 732 may be responsible for controlling or interfacing with the underlying hardware layer 704. For instance, the drivers 732 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 716 may provide a common infrastructure that may be used by the applications 720 and/or other components and/or layers. The libraries 716 typically provide functionality for use by other software modules to perform tasks, rather than rather than interacting directly with the OS 714. The libraries 716 may include system libraries 734 (for example, C standard library) that may provide functions such as memory allocation, string manipulation, file operations. In addition, the libraries 716 may include API libraries 736 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 716 may also include a wide variety of other libraries 738 to provide many functions for applications 720 and other software modules.

The frameworks 718 (also sometimes referred to as middleware) provide a higher-level common infrastructure that may be used by the applications 720 and/or other software modules. For example, the frameworks 718 may provide various graphic user interface (GUI) functions, high-level resource management, or high-level location services. The frameworks 718 may provide a broad spectrum of other APIs for applications 720 and/or other software modules.

The applications 720 include built-in applications 740 and/or third-party applications 742. Examples of built-in applications 740 may include, but are not limited to, a contacts application, a browser application, a location application, a media application, a messaging application, and/or a game application. Third-party applications 742 may include any applications developed by an entity other than the vendor of the particular platform. The applications 720 may use functions available via OS 714, libraries 716, frameworks 718, and presentation layer 744 to create user interfaces to interact with users.

Some software architectures use virtual machines, as illustrated by a virtual machine 748. The virtual machine 748 provides an execution environment where applications/modules can execute as if they were executing on a hardware machine (such as the machine 800 of FIG. 8, for example). The virtual machine 748 may be hosted by a host OS (for example, OS 714) or hypervisor, and may have a virtual machine monitor 746 which manages operation of the virtual machine 748 and interoperation with the host operating system. A software architecture, which may be different from software architecture 702 outside of the virtual machine, executes within the virtual machine 748 such as an OS 750, libraries 752, frameworks 754, applications 756, and/or a presentation layer 758.

FIG. 8 is a block diagram illustrating components of an example machine 800 configured to read instructions from a machine-readable medium (for example, a machine-readable storage medium) and perform any of the features described herein. The example machine 800 is in a form of a computer system, within which instructions 816 (for example, in the form of software components) for causing the machine 800 to perform any of the features described herein may be executed.

As such, the instructions 816 may be used to implement modules or components described herein. The instructions 816 cause unprogrammed and/or unconfigured machine 800 to operate as a particular machine configured to carry out the described features. The machine 800 may be configured to operate as a standalone device or may be coupled (for example, networked) to other machines. In a networked deployment, the machine 800 may operate in the capacity of a server machine or a client machine in a server-client network environment, or as a node in a peer-to-peer or distributed network environment. Machine 800 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 800 is illustrated, the term “machine” includes a collection of machines that individually or jointly execute the instructions 816.

The machine 800 may include processors 810, memory 830, and I/O components 850, which may be communicatively coupled via, for example, a bus 802. The bus 802 may include multiple buses coupling various elements of machine 800 via various bus technologies and protocols. In an example, the processors 810 (including, for example, a central processing unit (CPU), a graphics processing unit (GPU), a digital signal processor (DSP), an ASIC, or a suitable combination thereof) may include one or more processors 812a to 812n that may execute the instructions 816 and process data. In some examples, one or more processors 810 may execute instructions provided or identified by one or more other processors 810. The term “processor” includes a multi-core processor including cores that may execute instructions contemporaneously. Although FIG. 8 shows multiple processors, the machine 800 may include a single processor with a single core, a single processor with multiple cores (for example, a multi-core processor), multiple processors each with a single core, multiple processors each with multiple cores, or any combination thereof. In some examples, the machine 800 may include multiple processors distributed among multiple machines.

The memory/storage 830 may include a main memory 832, a static memory 834, or other memory, and a storage unit 836, both accessible to the processors 810 such as via the bus 802. The storage unit 836 and memory 832, 834 store instructions 816 embodying any one or more of the functions described herein. The memory/storage 830 may also store temporary, intermediate, and/or long-term data for processors 810. The instructions 816 may also reside, completely or partially, within the memory 832, 834, within the storage unit 836, within at least one of the processors 810 (for example, within a command buffer or cache memory), within memory at least one of I/O components 850, or any suitable combination thereof, during execution thereof. Accordingly, the memory 832, 834, the storage unit 836, memory in processors 810, and memory in I/O components 850 are examples of machine-readable media.

As used herein, “machine-readable medium” refers to a device able to temporarily or permanently store instructions and data that cause machine 800 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 816) for execution by a machine 800 such that the instructions, when executed by one or more processors 810 of the machine 800, cause the machine 800 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 850 may include a wide variety of hardware components adapted to receive input, provide output, produce output, transmit information, exchange information, capture measurements, and so on. The specific I/O components 850 included in a particular machine will depend on the type and/or function of the machine. For example, mobile devices such as mobile phones may include a touch input device, whereas a headless server or IoT device may not include such a touch input device. The particular examples of I/O components illustrated in FIG. 8 are in no way limiting, and other types of components may be included in machine 800. The grouping of I/O components 850 are merely for simplifying this discussion, and the grouping is in no way limiting. In various examples, the I/O components 850 may include user output components 852 and user input components 854. User output components 852 may include, for example, display components for displaying information (for example, a liquid crystal display (LCD) or a projector), acoustic components (for example, speakers), haptic components (for example, a vibratory motor or force-feedback device), and/or other signal generators. User input components 854 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 850 may include biometric components 856, motion components 858, environmental components 860, and/or position components 862, among a wide array of other physical sensor components. The biometric components 856 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 858 may include, for example, acceleration sensors (for example, an accelerometer) and rotation sensors (for example, a gyroscope). The environmental components 860 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 862 may include, for example, location sensors (for example, a Global Position System (GPS) receiver), altitude sensors (for example, an air pressure sensor from which altitude may be derived), and/or orientation sensors (for example, magnetometers).

The I/O components 850 may include communication components 864, implementing a wide variety of technologies operable to couple the machine 800 to network(s) 870 and/or device(s) 880 via respective communicative couplings 872 and 882. The communication components 864 may include one or more network interface components or other suitable devices to interface with the network(s) 870. The communication components 864 may include, for example, components adapted to provide wired communication, wireless communication, cellular communication, Near Field Communication (NFC), Bluetooth communication, Wi-Fi, and/or communication via other modalities. The device(s) 880 may include other machines or various peripheral devices (for example, coupled via USB).

In some examples, the communication components 864 may detect identifiers or include components adapted to detect identifiers. For example, the communication components 864 may include Radio Frequency Identification (RFID) tag readers, NFC detectors, optical sensors (for example, one-or multi-dimensional bar codes, or other optical codes), and/or acoustic detectors (for example, microphones to identify tagged audio signals). In some examples, location information may be determined based on information from the communication components 864, such as, but not limited to, geo-location via Internet Protocol (IP) address, location via Wi-Fi, cellular, NFC, Bluetooth, or other wireless station identification and/or signal triangulation.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or clement in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

Generally, functions described herein (for example, the features illustrated in FIGS. 1-6) can be implemented using software, firmware, hardware (for example, fixed logic, finite state machines, and/or other circuits), or a combination of these implementations. In the case of a software implementation, program code performs specified tasks when executed on a processor (for example, a CPU or CPUs). The program code can be stored in one or more machine-readable memory devices. The features of the techniques described herein are system-independent, meaning that the techniques may be implemented on a variety of computing systems having a variety of processors. For example, implementations may include an entity (for example, software) that causes hardware to perform operations, e.g., processors functional blocks, and so on. For example, a hardware device may include a machine-readable medium that may be configured to maintain instructions that cause the hardware device, including an operating system executed thereon and associated hardware, to perform operations. Thus, the instructions may function to configure an operating system and associated hardware to perform the operations and thereby configure or otherwise adapt a hardware device to perform functions described above. The instructions may be provided by the machine-readable medium through a variety of different configurations to hardware elements that execute the instructions.

In the foregoing detailed description, numerous specific details were set forth by way of examples in order to provide a thorough understanding of the relevant teachings. It will be apparent to persons of ordinary skill, upon reading the description, that various aspects can be practiced without such details. In other instances, well known methods, procedures, components, and/or circuitry have been described at a relatively high-level, without detail, in order to avoid unnecessarily obscuring aspects of the present teachings.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows, and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein.

Relational terms such as first and second and the like may be used solely to distinguish one entity or action from another without necessarily requiring or implying any actual such relationship or order between such entities or actions. The terms “comprises,” “comprising,” and any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “a” or “an” does not, without further constraints, preclude the existence of additional identical elements in the process, method, article, or apparatus that comprises the element.

The Abstract of the Disclosure is provided to allow the reader to quickly identify the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that any claim requires more features than the claim expressly recites. Rather, as the following claims reflect, inventive subject matter lies in less than all features of a single disclosed example. Thus, the following claims are hereby incorporated into the Detailed Description. with each claim standing on its own as a separately claimed subject matter.

What is claimed is:

1. A data processing system comprising:
a processor; and
a memory in communication with the processor, the memory comprising executable instructions that, when executed by the processor alone or in combination with other processors, cause the data processing system to perform functions of:
detecting failure of a main Continuous Integration Testing (CIT) pipeline that is testing artifacts of a build pipeline;
determining a known-good artifact tested by the main CIT pipeline previously;
retesting the known-good artifact with a duplicate CIT pipeline; and
in response to failure of the duplicate CIT pipeline, enhancing an incident ticket with notice that the failure of the main CIT pipeline is due to an external dependency failure.

2. The system of claim 1, wherein determining a known-good artifact tested by the main CIT pipeline previously and retesting the known-good artifact with a duplicate CIT pipeline are conducted regularly during operation of the build pipeline in anticipation of detecting a failure of the main CIT pipeline.

3. The system of claim 1, wherein determining a known-good artifact tested by the main CIT pipeline previously and retesting the known-good artifact with a duplicate CIT pipeline are triggered by detecting the failure of the main CIT pipeline.

4. The system of claim 1, further comprising receiving user input to invoke determining a known-good artifact tested by the main CIT pipeline previously and retesting the known-good artifact with a duplicate CIT pipeline.

5. The system of claim 1, wherein the known-good artifact retested with the duplicate CIT pipeline is a release artifact from a release pipeline in a Continuous Integration/Continuous Deployment (CI/CD) system with the build pipeline.

6. The system of claim 1, wherein the duplicate CIT pipeline contains only a subset of stages contained in the main CIT pipeline.

7. The system of claim 6, wherein the duplicate CIT pipelines contains only stages that, if unsuccessful, prevent additional code from being checked in to a codebase repository.

8. The system of claim 1, further comprising retesting the known-good artifact with the duplicate CIT pipeline multiple times to allow a transient issue in an external dependency to resolve before determining failure of the duplicate CIT pipeline and issuing the incident ticket.

9. The system of claim 1, further comprising determining that a number of same releases stages are failing in the main and duplicate CIT pipeline before determining failure of the CIT pipeline and enhancing the incident ticket.

10. The system of claim 1, if the incident ticket remains active, on a regular basis querying logs of the duplicate CIT pipeline for failures and updating the incident ticket accordingly.

11. The system of claim 10, wherein the regular basis is hourly.

12. A diagnostic tool for a Continuous Integration/Continuous Deployment (CI/CD) system having a codebase repository and build and release pipelines, the diagnostic tool to identify failure in an external dependency as a cause of a failure in Continuous Integration Testing (CIT), the diagnostic tool comprising a processor; and a memory in communication with the processor, the memory comprising executable instructions that, when executed by the processor alone or in combination with other processors, cause the processor to implement an agentless task to perform functions of:
detecting and responding to a testing failure of a main Continuous Integration Testing (CIT) pipeline that is testing artifacts of the build pipeline;
determining a known-good artifact tested by the main CIT pipeline previous to the failure;
instantiating a duplicate CIT pipeline;
rerunning CIT based on the known-good artifact with the duplicate CIT pipeline;
determining a testing failure of the duplicate CIT pipeline; and
enhancing an incident ticket for the testing failure in the main CIT pipeline with notice that the testing failure of the main CIT pipeline is due to an external dependency outage.

13. The tool of claim 12, wherein determining a known-good artifact tested by the main CIT pipeline previously and rerunning testing of the known-good artifact with a duplicate CIT pipeline are conducted regularly during operation of the build pipeline in anticipation of detecting a failure of the main CIT pipeline.

14. The tool of claim 13, wherein operation of the duplicate CIT pipeline is in cadence with operation of the main CIT pipeline.

15. The tool of claim 12, wherein the duplicate CIT pipeline contains only a subset of stages contained in the main CIT pipeline.

16. The tool of claim 15, wherein the duplicate CIT pipelines contains only stages that, if unsuccessful, prevent additional code from being checked in to a codebase repository.

17. The tool of claim 12, wherein the agentless task is configurable for retesting the known-good artifact with the duplicate CIT pipeline multiple times to allow a transient issue in an external dependency to resolve before determining failure of the duplicate CIT pipeline and issuing the incident ticket.

18. A method of diagnosing a Continuous Integration/Continuous Deployment (CI/CD) system having a codebase repository and build and release pipelines, the method to identify failure in an external dependency as a cause of a failure in Continuous Integration Testing (CIT), the method comprising:
detecting and responding to a testing failure of a main Continuous Integration Testing (CIT) pipeline that is testing artifacts of the build pipeline;
determining a known-good artifact tested by the main CIT pipeline previous to the failure;
instantiating a duplicate CIT pipeline;
rerunning CIT based on the known-good artifact with the duplicate CIT pipeline;
determining a testing failure of the duplicate CIT pipeline; and
enhancing an incident ticket for the testing failure in the main CIT pipeline with notice that the testing failure of the main CIT pipeline is due to an external dependency outage.

19. The method of claim 18, wherein determining a known-good artifact tested by the main CIT pipeline previously and rerunning testing of the known-good artifact with a duplicate CIT pipeline are conducted regularly during operation of the build pipeline in anticipation of detecting a failure of the main CIT pipeline.

20. The method of claim 18, wherein the duplicate CIT pipeline contains only a subset of stages contained in the main CIT pipeline, the duplicate CIT pipelines containing only stages that, if unsuccessful, prevent additional code from being checked in to a codebase repository.
